(19) United States
(12) Patent Application Publication
(10) Pub. No.: US 2026/0114445 A1
(43) Pub. Date: Apr. 30, 2026

(54) STABLE ANTIMICROBIAL FORMULATION CONCENTRATE

(71) Applicant: Kimberly-Clark Worldwide, Inc., Neenah, WI (US)

(72) Inventors: Andrew R. Kischnick, Appleton, WI (US); Amy L. Vanden Heuvel, Hortonville, WI (US)

(21) Appl. No.: 18/034,111

(22) PCT Filed: Oct. 30, 2020
(86) PCT No.: PCT/US20/58110

§ 371 Date: Apr. 27, 2023

(51) Int. Cl. A01N 25/30; A01N 25/22; A01N 31/02; A01N 35/04; A01P 1/00

(52) U.S. Cl. CPC A01N 25/30; A01N 25/22; A01N 31/02; A01N 35/04; A01P 1/00

(57) ABSTRACT

Compositions providing a stabilized antimicrobial formulation concentrate are described. The composition can include at least one glycol. The at least one glycol can include a first glycol with a carbon chain with less than six carbons. In some variations, the composition can include a non-ionic surfactant. The composition can also include hydroxyacetophenone. The hydroxyacetophenone can provide at least 10% of the composition by weight.

### TECHNICAL FIELD

Disclosed are antimicrobial formulation concentrates and methods of inhibiting microbial growth. More specifically, disclosed is an antimicrobial formulation concentrate that includes at least one glycol and hydroxyacetophenone. After diluting, the antimicrobial composition concentrate may be used for or incorporated into articles such as wipes, or into solutions, ointments, lotions, creams, salves, aerosols, gels, suspensions, sprays, foams, washes, or the like.

### BACKGROUND OF THE DISCLOSURE

Preservatives are an often utilized component in cosmetic, pharmaceutical, household, industrial, and personal care products to ensure that a product stays fresh on the shelf, doesn't experience spoilage, and remains free from bacterial growth. In particular, because personal care products may be used to directly contact skin or mucosa such as around body orifices where the potential for transfer of materials from the product to the consumer may be a concern, it is generally good practice to reduce contamination of the product in every possible way. The need to control microbiological growth is particularly acute in water based products such as non-ionic oil-in-water emulsions and in pre-impregnated wipes such as wet wipes.

Multiple options for antimicrobial agents that prevent microbial growth, such as formaldehyde donors or parabens, have existed throughout history and these antimicrobial agents were highly efficacious and allowed for relatively easy preservation of personal care products. Recently, traditional antimicrobial agents have been less desirable components in personal care products in view of new regulations and consumer perceptions, thus limiting the options for preventing microbial growth in certain products.

While alternative antimicrobial agents have been explored, each carry limitations. For example, some organic acids and their derivatives have been used for their antimicrobial effect, however, organic acids tend to have an inherent odor, thus limiting the concentration that can be used without negatively affecting the overall olfactory perception of the product. Additionally, organic acids often are only efficacious in the acid form, thus limiting their use to compositions having a narrow and low pH range, and also have limited water solubility. Caprylhydroxamic Acid has also been explored as an alternative antimicrobial agent and addresses some of the issues noted above (in that Caprylhydroxamic Acid does not have odor issues and is efficacious across a broader pH range), however, Caprylhydroxamic Acid has a very limited water solubility of approximately 0.14%. This limited water solubility prevents Caprylhydroxamic Acid from being used at higher percentages in compositions with limited ingredients.

One antimicrobial ingredient that addresses many of these issues is hydroxyacetophenone. Hydroxyacetophenone has been determined to have efficacy against a wide variety of microorganisms, including difficult-to-kill organisms such as A. brasiliensis and C. albicans. The efficacy of hydroxyacetophenone has little pH dependence, which allows it to be used effectively in a wide variety of formulations and provides more formulation flexibility than typical organic acid preservatives. In addition to its antimicrobial benefits, hydroxyacetophenone also offers other benefits, including antioxidant and anti-irritant effects. Thus, there remains a need for antimicrobial compositions that include alternative antimicrobial agents that can be used in a composition to inhibit microbial growth in a product and that have lower odor, can be used in a composition over a wider pH range without losing efficacy against microbial growth, and can have greater water solubility than prior alternative antimicrobial agents.

While hydroxyacetophenone offers important benefits, it also has drawbacks and challenges for incorporating in an antimicrobial formulation. For example, one drawback is that hydroxyacetophenone in its pure form is typically produced as a crystalline solid or powder. This requires blending facilities to use either manual labor to weigh and add hydroxyacetophenone (which can add potential labor costs), or to utilize specialized solids-handling equipment (which results in capital costs and may require additional floor space at the manufacturing facility).

Additionally, hydroxyacetophenone has limited water solubility (1% at 22° C.), which can make it difficult to dissolve in highly aqueous formulations, such as those used in many personal care products. Fully dissolving hydroxyacetophenone at levels effective for antimicrobial activity often requires vigorous and extended blending time and/or heating the batch to elevated temperatures during the blending process. For manufacturing facilities without heating capability, this could result in long batching times that significantly reduce efficiency and limit throughput.

One option to expedite blending of formulations containing hydroxyacetophenone would be to pre-blend the hydroxyacetophenone into a concentrate with other formulation ingredients that could potentially be blended off-site at a location with greater blending/heating capabilities and then shipped to the final manufacturing location, where it could be diluted and blended with other formulation ingredients to produce the final diluted antimicrobial formulation. However, this approach also provides several challenges. Because hydroxyacetophenone has limited water solubility, increasing the concentration of the ingredient makes it even more challenging to dissolve, and will often result in hydroxyacetophenone crystallizing out of solution, particularly at low temperatures such as those that may be encountered during shipping.

While surfactants and solvents can be used to help improve the solubility of hydroxyacetophenone in the concentrate, consumers are increasingly demanding cosmetic formulations that contain low numbers and concentrations of non-water ingredients, as these ingredients are perceived to be not as “pure” or “natural” as water. Additionally, adding other solublizers can lead to increased overall formulation cost. For any concentrate, it is further desirable to maximize the concentration of hydroxyacetophenone in the blend in order to minimize the blending and shipping costs of the concentrate from the concentrate blending facility to the final manufacturing facility.

For these reasons, it would be highly desirable to produce a concentrate that includes a high concentration of hydroxyacetophenone, with a minimal number of other ingredients in the concentrate and that are present at low concentrations relative to hydroxyacetophenone. Such a concentrate blend would offer significant benefits to manufacturing flexibility, capital expenditure, product cost, and consumer delight.

### SUMMARY OF THE DISCLOSURE

In one aspect of the disclosure, a composition is provided. The composition can include at least one glycol. The at least one glycol can include a first glycol having a carbon chain with less than six carbons. The composition can also include a non-ionic surfactant. The composition can further include hydroxyacetophenone. Hydroxyacetophenone can provide at least 10% of the composition by weight.

In another aspect of the disclosure, another composition is provided. The composition can include a first glycol. The first glycol can include a carbon chain with less than six carbons. The composition can also include a second glycol. The composition can additionally include a non-ionic surfactant. Further, the composition can include hydroxyacetophenone.

In still another aspect of the disclosure, a composition is provided. The composition can include a first glycol at a first weight percentage of the composition. The composition can also include caprylyl glycol at a second weight percentage of the composition. The first weight percentage and the second weight percentage can provide a total glycol weight percentage of the composition. The composition can also include hydroxyacetophenone at an amount of at least 10% of the composition by weight. A ratio of the total glycol weight percentage to the amount of hydroxyacetophenone is greater than 4.0.

### DETAILED DESCRIPTION OF THE DISCLOSURE

The present disclosure is directed to compositions that can be utilized to inhibit microbial growth. The compositions of the present disclosure include at least one glycol and the antimicrobial ingredient of hydroxyacetophenone. In preferred embodiments, the compositions of the present disclosure can be in the form of a concentrate, such that the hydroxyacetophenone is greater than 10% by weight of the composition. The concentrate composition can be later diluted (e.g., such as through dilution with water) and/or or with other functional and non-functional ingredients to form an antimicrobial composition useful for a wide variety of products, such as cosmetic, pharmaceutical, household, food, industrial, and personal care products. Suitable products could include, but are not limited to: shampoo, conditioner, soaps, moisturizers, skin protective, skin restorative and skin strengthening products, hand sanitizers, skin and body cleansers, deodorants, sunscreens, lip balms, lip sticks, disinfectants, hard surface cleansers, dish soaps, laundry detergents and the like. These products could take a variety of forms including but not limited to water-thin liquids, aqueous solutions, gels, balms, lotions, ointments, suspensions, creams, milks, salves, ointments, pastes, powders, aerosols, sprays, mists, mousses, emulsions, oils, foams, washes, solid sticks, aerosols, water, oil or silicone solutions or emulsions, including water in oil, oil in water, silicone in water, water in silicone and the like. Additionally, as will be described in further detail below, the forms of these products may be used in conjunction with a substrate, such that the solution may be added to the substrate for delivery. Suitable substrate based products include, but are not limited to: wipes, facial tissue, bath tissue, paper towels, napkins, diapers, diaper pants, feminine hygiene products (tampons, pads), gloves, socks, masks or combinations thereof.

Within each of the above envisioned products, the composition can be diluted and used with a variety of ingredients utilized in cosmetic, pharmaceutical, household, industrial, and personal care products. Suitable ingredients, some of which will be described in further detail herein, can come from a broad category range including, but not limited to aqueous solvents, non-aqueous solvents, humectants, emollients, surfactants, emulsifiers, builders, sequestrants, chelators, preservatives, pH modifiers, combinatorial preservatives/antimicrobial agents, disinfectants, colorants, rheology modifiers, antioxidants, anti-parasitic agents, antipruritics, antifungals, antiseptic actives, biological actives, astringents, keratolytic actives, local anaesthetics, anti-stinging agents, anti-reddening agents, skin soothing agents, external analgesics, film formers, skin exfoliating agents, sunscreens, deodorants, antiperspirants, fragrance, and various other optional ingredients as are known by one skilled in the art.

### Antimicrobial Agents

The antimicrobial compositions of this disclosure include an antimicrobial agent that can be hydroxyacetophenone. As noted above, hydroxyacetophenone is known for its antimicrobial properties. Hydroxyacetophenone is a simple aromatic ketone that takes the form of a colorless crystalline solid. Typically used at levels from 0-1.0% (by weight) in finished products, hydroxyacetophenone offers several benefits in personal care products, such as anti-oxidant and anti-irritant activity in addition to its antimicrobial and preservative boosting benefits. Represented by the structure below, hydroxyacetophenone is an effective, broad-spectrum antimicrobial agent but as stated above, it inherently has limited water solubility, which can make it challenging to blend into highly aqueous formulations, such as those used in many personal care products.

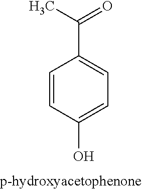

In the present disclosure focused on antimicrobial compositions in concentrate form, hydroxyacetophenone can comprise at least 10% by weight of the composition. In some embodiments, hydroxyacetophenone can comprise greater than 12% by weight of the composition, greater than 15%, or even greater than 20% by weight of the composition in concentrate form.

After the concentrate is diluted, hydroxyacetophenone can comprise less than about 1.0% of the composition, or less than about 0.5%, or less than about 0.2% by weight of the composition in some embodiments.

### Solubilizers

The compositions of the present disclosure can also include a solubilizer. The solubilizer can help dissolve the hydroxyacetophenone into a liquid concentrate. The solubilizers researched, as will be discussed in further detail below, included glycereth-7 benzoate, hexyglycerin, methylpropanediol, PPG-2 phenyl ether, phenoxyisopropanol, propanediol, butylene glycol, 1,2-hexanediol, isoprene glycol, pentylene glycol, butyloctanol, and caprylyl glycol.

Initial research was conducted to address the issues of hydroxyacetophenone and experiments were conducted to blend the hydroxyacetophenone into a liquid concentrate that included high concentrations of hydroxyacetophenone and relatively low numbers and concentrations of other formulation ingredients, such as solubilizers. It was preferred to try to utilize no more than two or three additional ingredients in order to minimize the number of ingredients that are added to the ingredient listing on the packaging of the formulated product.

The ingredients that were experimented with were common solubilizers that are used in cosmetic products. Stability testing was conducted using the methodology described in the Test Methods section herein. Early stability testing focused on combining various solubilizers at a 2:1 ratio with hydroxyacetophenone at 50° C. and then allowing the samples to sit for a number of days at room temperature to determine whether a precipitate would form. Focus was placed on solubilizers that could be easily diluted with water to produce a final product that would remain stable throughout an extended shelf life.

Of the solubilizers that were examined, only two did not exhibit precipitation when combined at a 2:1 ratio with hydroxyacetophenone after 4 days of storage at room temperature. Those solubilizers were butylene glycol and isoprene glycol. Other solubilizers, even other glycol solubilizers such as pentylene glycol, methylpropanediol and 1,2-hexanediol were not able to maintain stability of the hydroxyacetophenone at room temperature. Table 1 describes many of the combinations that were evaluated. If a code produced a precipitate during stability testing at 4 days at 25° C., then that code was not tested at 1 month at 5° C., marked as “N/T”.

TABLE 1
Blends with hydroxyacetophenone and various solubilizers

| | | | | | | Stability | Stability |
|---|---|---|---|---|---|---|---|
| | Hydroxyacetophenone | | Solubilizer 1 | | Solubilizer 2 | Results | Results |
| | concentr. | | concentr. | | concentr. | (4 days at | (1 mo. at |
| Code | (wt. %) | Solubilizer 1 | (wt %) | Solubilizer 2 | (wt. %) | 25° C.) | 5° C.) |
| A | 33.33 | Dermol G-76 | 66.67 | N/A | N/A | Precipitate | N/T |
| | | (Glycereth-7 | | | | | |
| | | Benzoate) | | | | | |
| B | 33.33 | Adeka NOL | 66.67 | N/A | N/A | Precipitate | N/T |
| | | NHG | | | | | |
| | | (Hexylglycerin) | | | | | |
| C | 33.33 | Dub Diol | 66.67 | N/A | N/A | Precipitate | N/T |
| | | (Methylpropa | | | | | |
| | | nediol) | | | | | |
| D | 33.33 | Dowanol | 66.67 | N/A | N/A | Precipitate | N/T |
| | | DiPPh | | | | | |
| | | (PPG-2 | | | | | |
| | | Phenyl Ether) | | | | | |
| E | 33.33 | Dowanol PPh | 66.67 | N/A | N/A | Precipitate | N/T |
| | | (Phenoxyisop | | | | | |
| | | ropanol) | | | | | |
| F | 33.33 | Zemea | 66.67 | N/A | N/A | Precipitate | N/T |
| | | (Propanediol) | | | | | |
| G | 33.33 | 1,3 Butylene | 66.67 | N/A | N/A | No precipitate | Precipitate |
| | | Glycol | | | | | |
| | | (Butylene | | | | | |
| | | Glycol) | | | | | |
| H | 33.33 | Hydrolite 6 | 66.67 | N/A | N/A | Precipitate | N/T |
| | | (1,2- | | | | | |
| | | hexanediol) | | | | | |
| I | 50.00 | 1,3 Butylene | 50.00 | N/A | N/A | Precipitate | N/T |
| | | Glycol | | | | | |
| | | (Butylene | | | | | |
| | | Glycol) | | | | | |
| J | 33.33 | Isoprene | 66.67 | N/A | N/A | No precipitate | Precipitate |
| | | Glycol | | | | | |
| K | 22.22 | 1,3 Butylene | 44.44 | Eumulgin | 33.33 | No precipitate | No |
| | | Glycol | | SML-20 | | | precipitate |
| | | (Butylene | | (Polysorbate- | | | |
| | | Glycol) | | 20) | | | |
| L | 33.33 | Hydrolite 5 | 66.67 | N/A | N/A | Precipitate | N/T |
| | | (Pentylene | | | | | |
| | | Glycol) | | | | | |
| M | 33.33 | Isofol 12 | 66.67 | N/A | N/A | Precipitate | N/T |
| | | (Butyloctanol) | | | | | |
| N | 25.00 | Lexgard O | 75.00 | N/A | N/A | No precipitate | Crystallizes |
| | | (Caprylyl | | | | | (no crystals |
| | | Glycol) | | | | | upon |
| | | | | | | | thawing) |

As documented in Table 1, most solubilizers were not able to mix with hydroxyacetophenone and remain stable for 4 days at 25° C. Codes G and J including solubilizers butylene glycol and isoprene glycol, respectively, showed promise as not having a precipitate in the solution after being stored at 4 days at 25° C. However, these blends that passed short-term aging at room temperature continued to be stored at room temperature for one month and were also placed in a 5° C. refrigerator for one month. After this time, both Code G with the butylene glycol and Code J with the isoprene glycol solubilized with the hydroxyacetophenone exhibited a precipitate, and thus, did not pass the stability testing.

Since an effective concentrate blend must be able to survive a wide range of temperatures without precipitating, further efforts were made to improve the stability of the concentrate blends at low temperatures. Although increasing the concentration of the solubilizer and decreasing the concentration of the hydroxyacetophenone in the concentrate would eventually result in a stable blend, increasing the concentration of the solubilizer results in a proportional increase of that material in the final diluted solution. This increases the cost of the final solution and also increases the concentration of non-water ingredients in the final formulation, which is contrary to the desires of many consumers for a high-water product with minimal additives. Therefore, rather than simply increasing the concentration of solubilizer, further research was conducted to add an additional ingredient to the concentrate, but to focus on ingredients that would likely be found in the final formulation. In this way, the stability of the concentrate might be improved without an increase in cost or concentrate of non-water ingredients in the final product.

Further experimentation was conducted on formulations by adding a surfactant as an additional ingredient because many personal care formulations utilize surfactants to solubilize oils and to provide detergency. Nonionic surfactants were initially selected because they are commonly used to solubilize fragrance and botanical oils, are often inexpensive and have less risk of compatibility issues in the final formulation than cationic or anionic surfactants.

One particular nonionic surfactant that is commonly used in personal care products is polysorbate-20 (Eumulgin SML-20 from BASF). As shown in Code K in Table 1, polysorbate-20 was combined with hydroxyacetophenone and butylene glycol in a nonaqueous blend at a 10:20:9 ratio by weight (butylene glycol/polysorbate 20/hydroxyacetophenone). Code K successfully passed stability testing at a wide variety of temperatures, from 5° C. to 55° C., with no evidence of precipitation. Other ratios of these three ingredients were tested and also remained stable at both 5° C. and 25° C. for at least one month, including butylene glycol/polysorbate-20/hydroxyacetophenone ratios of 20:15:10, 10:15:10, and 10:25:10. However, 20:5:10 and 20:15:20 ratios did not exhibit stability under these conditions, as precipitation occurred from the concentrate blend.

Other non-ionic surfactants other than polysorbate-20 were also tested with compositions including butylene glycol and hydroxyacetophenone. As documented in Table 2, 1 month and 3 month stability testing was completed on various non-ionic surfactants at 23% with 26% hydroxyacetophenone and 51% butylene glycol. This stability testing was completed at 5° C., 25° C., and 40° C.

TABLE 2
Stability testing with non-ionic surfactants

| | 1 month | 3 month |
|---|---|---|
| Non-Ionic Surfactant INCI | stability | stability |
| Polysorbate-20 | No precipitate | No precipitate |
| Polysorbate-80 | No precipitate | No precipitate |
| PEG-40 Hydrogenated Castor Oil | No precipitate | No precipitate |
| Polyglyceryl-3 caprate | No precipitate | No precipitate |
| Trideceth-6 | No precipitate | No precipitate |
| Trideceth-18 | No precipitate | No precipitate |

As displayed in Table 2, various different non-ionic surfactants passed the stability testing for 1 month and 3 months at 5° C.-40° C. Cationic and anionic surfactants were not explored because they are likely to have much more risk of compatibility issues in the final formulation.

In some embodiments, concentrated compositions of the present disclosure can include a non-ionic surfactant that comprises at least 25% of the composition (by weight). In some embodiments, a non-ionic surfactant can comprise greater than 30%, greater than 35%, greater than 40%, greater than 45%, or even greater than 50% of the composition (by weight).

Amounts of non-ionic surfactants may range from 0.01 to 30%, or from 10 to 30%, or from 0.05 to 20%, or from 0.10 to 15% by total weight of the final diluted antimicrobial composition in some embodiments. In some embodiments, amounts of non-ionic surfactants may range from 0.01 to 10.0%, or from 0.01-5.0%, or from 0.01 to 1.0% by total weight of the final diluted antimicrobial composition.

Additional stability testing was also completed to look at the stability of other glycols in compositions including hydroxyacetophenone. Table 3 provides the stability testing results for various glycol solubilizers at a 20:10:9 ratio (51%:26%:23%) of glycol:hydroxyacetophenone:polysorbate 20.

TABLE 3
Stability testing with various glycol solubilizers

| | | Empirical | 1-month | 3-month | Stability without |
|---|---|---|---|---|---|
| Solubilizer INCI | # Carbons | Formula | stability | stability | Polysorbate 20 |
| Glycerin | 3 | C₃H₈O₃ | Precipitate | Precipitate | NT |
| Propylene Glycol | 3 | C₃H₈O₂ | No Precipitate | No Precipitate | NT |
| Butylene Glycol | 4 | C₄H₁₀O₂ | No Precipitate | No Precipitate | Precipitate |
| Methylpropanediol | 4 | C₄H₁₀O₂ | No Precipitate | No Precipitate | Precipitate |
| 1,2-Hexanediol | 6 | C₆H₁₄O₂ | Precipitate | Precipitate | NT |
| Caprylyl Glycol | 8 | C₈H₁₈O₂ | Precipitate | Precipitate | NT |

From the results documented in Table 3, it can be seen that various glycols can provide adequate stability, yet others did not. For example, glycerin, 1,2-hexanediol, and caprylyl glycol did not provide adequate stability. But, propylene glycol, butylene glycol, and methylpropanediol all provided adequate stability results. From these results, it appears that glycols including a carbon chain with less than six carbons was preferable for achieving adequate stability.

Additionally, the results from the stability testing documented Table 3 also provide that proper stability was not achieved if the non-ionic surfactant of polysorbate-20 was removed from the composition. Thus, in some compositions and amounts of a glycol and hydroxyacetophenone, it appears that a non-ionic surfactant may be beneficial for achieving a stable concentrate composition.

In addition to blends consisting of hydroxyacetophenone, butylene glycol, and a surfactant, a second, larger chain length glycol may be added to the concentrate in order to facilitate incorporation of a second antimicrobial ingredient. Caprylyl glycol (Lexgard O from Inolex or Hydrolite CG from Symrise) is a 1,2-diol with known antimicrobial properties. It can be used as an effective co-antimicrobial in combination with hydroxyacetophenone. Caprylyl glycol has limited water solubility, so it also can be difficult to incorporate at high concentrations in aqueous formulation concentrates. However, when added in a concentrate with butylene glycol, a nonionic surfactant, and hydroxyacetophenone, a concentrate that is stable at a wide variety of temperatures for an extended period of time can be generated. For example, incorporating 30 parts caprylyl glycol to a 20:9:10 blend of butylene glycol/polysorbate-20/hydroxyacetophenone creates a concentrate that is stable at 5° C.-40° C. for at least one month.

In fact, blends that incorporate caprylyl glycol along with another short chain glycol may remain stable even in the absence of a non-ionic surfactant, or when the composition is substantially free from a non-ionic surfactant. For purposes herein, a concentrated composition can be substantially free from a non-ionic surfactant when it includes less than 1% of a non-ionic surfactant. Table 4 summarizes combinations of caprylyl glycol, short-chain glycols and hydroxyacetophenone that were evaluated, along with their corresponding stability results.

TABLE 4
Stability testing with two glycol solubilizers

| | | Caprylyl | Short chain | | Stability | Stability |
|---|---|---|---|---|---|---|
| | Hydroxyacetophenone | glycol | glycol - | Surfactant - | Results | Results |
| | concentr. | concentr. | concentr. | concentr. | (1 mo. at | (1 mo. at |
| Code | (wt %) | (wt %) | (wt. %) | (wt %) | 25° C.) | 5° C. |
| O | 33.33 | 33.33 | Zemea (Propanediol) - 33.33 | None | Precipitate | NT |
| P | 16.67 | 50.00 | Zemea (Propanediol) - 33.33 | None | No | Precipitate |
| | | | | | precipitate | |
| Q | 16.67 | 50.00 | Dub Diol | None | No | No |
| | | | (Methylpropanediol) - 33.33 | | precipitate | precipitate |
| R | 16.67 | 50.00 | 1,3 Butylene Glycol | None | No | No |
| | | | (Butylene Glycol) - 33.33 | | precipitate | precipitate |
| S | 20.00 | 60.00 | 1,3 Butylene Glycol | None | No | Precipitate |
| | | | (Butylene Glycol) - 20.00 | | precipitate | |
| T | 25.00 | 75.00 | None | None | No | Solidifies |
| | | | | | precipitate | (no crystals |
| | | | | | | upon |
| | | | | | | thawing) |
| U | 16.95 | 16.95 | 1,3 Butylene Glycol | Polysorbate-20 - | No | No |
| | | | (Butylene Glycol) - 33.90 | 15.25 | precipitate | precipitate |
| V | 16.95 | 33.90 | 1,3 Butylene Glycol | Hetoxol CAWS | No | No |
| | | | (Butylene Glycol) - 33.90 | (PPG-5-Ceteth-20) - | precipitate | precipitate |
| | | | | 15.26 | | |
| W | 14.50 | 29.00 | 1,3 Butylene Glycol | Hetoxol CAWS | No | No |
| | | | (Butylene Glycol) - 29.00 | (PPG-5-Ceteth-20) - | precipitate | precipitate |
| | | | | 27.55 | | |
| X | 14.50 | 43.50 | 1,3 Butylene Glycol | Hetoxol CAWS | No | No |
| | | | (Butylene Glycol) - 29.00 | (PPG-5-Ceteth-20) - | precipitate | precipitate |
| | | | | 13.05 | | |

As documented in Table 4, in codes that did not include a non-ionic surfactant, a significant concentration of caprylyl glycol relative to hydroxyacetophenone may be necessary to achieve stability. For example, a 30/20/10 mixture of caprylyl glycol/butylene glycol/hydroxyacetophenone was stable for at least one month at 5° C. and 25° C. (Code R), as was a 30/20/10 mixture of caprylyl glycol/methylpropanediol/hydroxyacetophenone (Code Q). These results are an improvement over the performance of concentrates that just utilize caprylyl glycol as a solvent because caprylyl glycol tends to solidify at low temperatures. For example, a blend of 3 parts caprylyl glycol to 1 part hydroxyacetophenone (Code T) solidified completely after a few days at 5° C., which could result in handling challenges if it were to happen in a manufacturing environment.

Some embodiments of the antimicrobial concentrate compositions of the present disclosure can be suitably made with at least one glycol, the at least one glycol can include a carbon chain with less than six carbons. In some embodiments, a glycol can comprise greater than 20% of the concentrate composition (by weight), or in some embodiments greater than 25%, greater than 30%, greater than 35%, or greater than 40% by weight the composition.

As described above, in some embodiments, two different glycols can be employed in the composition. In some embodiments, the two different glycols can include a first glycol with a carbon chain with less than six carbons and a second glycol. In preferred embodiments, the first glycol can include at least one of butylene glycol, methylpropanediol, and combinations thereof. In some embodiments, the second glycol can be caprylyl glycol. In some embodiments, the total glycol weight percentage (e.g., first glycol weight percentage and second glycol weight percentage combined) can be at least 75%, or at least 80%. In some embodiments, a ratio of the total glycol weight percentage to the amount of hydroxyacetophenone can be greater than 4.0. In some embodiments, a ratio of the weight percentage of the second glycol, such as caprylyl glycol, to the weight percentage of hydroxyacetophenone can be greater than 2.5.

In final diluted forms, the antimicrobial compositions can include one or more glycols in an amount of from about 0.01% to about 1.0%, or from about 0.1% to about 0.5% by weight of the composition in some embodiments.

### Carriers

The antimicrobial concentrate compositions of the present disclosure may be later diluted and formulated with one or more conventional and compatible carrier materials. Once diluted, the antimicrobial composition may take a variety of forms including, without limitation, aqueous solutions, gels, balms, lotions, suspensions, creams, milks, salves, ointments, sprays, emulsions, oils, resins, foams, solid sticks, aerosols, and the like. Liquid carrier materials suitable for can include those well-known for use in the cosmetic, pharmaceutical, and medical arts as a basis for ointments, lotions, creams, salves, aerosols, gels, suspensions, sprays, foams, washes, and the like, and may be used in their established levels. After dilution, the carrier can comprise from about 0.01% to about 99.98% (by total weight of the composition), depending on the carrier used.

Preferable carrier materials include polar solvent materials, such as water. Other potential carriers include emollients, humectants, polyols, surfactants, esters, perfluorocarbons, silicones, and other pharmaceutically acceptable carrier materials. In one embodiment, the carrier is volatile, allowing for immediate deposition of the antimicrobial ingredient to the desired surface while improving overall usage experience of the product by reducing drying time. Non-limiting examples of these volatile carriers include 5 cst Dimethicone, Cyclomethicone, Methyl Perfluoroisobutyl Ether, Methyl Perfluorobutyl Ether, Ethyl Perfluoroisobutyl Ether and Ethyl Perfluorobutyl Ether. Unlike conventional volatile carriers such as ethanol or isopropyl alcohol, these carriers have no antimicrobial effect.

In one embodiment, the antimicrobial compositions can optionally include one or more emollients, which typically act to soften, soothe, and otherwise lubricate and/or moisturize the skin. Suitable emollients that can be incorporated into the compositions include oils such as alkyl dimethicones, alkyl methicones, alkyldimethicone copolyols, phenyl silicones, alkyl trimethylsilanes, dimethicone, dimethicone crosspolymers, cyclomethicone, lanolin and its derivatives, fatty esters, fatty acids, glycerol esters and derivatives, propylene glycol esters and derivatives, alkoxylated carboxylic acids, alkoxylated alcohols, fatty alcohols, and combinations thereof.

Some embodiments of the antimicrobial compositions may include one or more emollients in an amount of from about 0.01% (by total weight of the composition) to about 20% (by total weight of the composition), or from about 0.05% (by total weight of the composition) to about 10% (by total weight of the composition), or from about 0.10% (by total weight of the composition) to about 5% (by total weight of the composition).

In some embodiments, the antimicrobial compositions include one or more esters. The esters may be selected from cetyl palmitate, stearyl palmitate, cetyl stearate, isopropyl laurate, isopropyl myristate, isopropyl palmitate, and combinations thereof. The fatty alcohols include octyldodecanol, lauryl, myristyl, cetyl, stearyl, behenyl alcohol, and combinations thereof. The fatty acids can include, but are not limited to, capric acid, undecylenic acid, lauric acid, Myristic acid, palmitic acid, stearic acid, oleic acid, linoleic acid, arachidic acid, and behenic acid. Ethers such as eucalyptol, ceteraryl glucoside, dimethyl isosorbic polyglyceryl-3 cetyl ether, polyglyceryl-3 decyltetradecanol, propylene glycol myristyl ether, and combinations thereof can also suitably be used as emollients. Other suitable ester compounds for use in the antimicrobial compositions or the present disclosure are listed in the International Cosmetic Ingredient Dictionary and Handbook, 11th Edition, CTFA, (January 2006) ISBN-10:1882621360, ISBN-13:978-1882621361, and in the 2007 Cosmetic Bench Reference, Allured Pub. Corporation (Jul. 15, 2007) ISBN-10:1932633278, ISBN-13:978-1932633276, both of which are incorporated by reference herein to the extent they are consistent herewith.

Humectants that are suitable as carriers in the antimicrobial compositions of the present disclosure include, for example, glycerin, glycerin derivatives, hyaluronic acid, hyaluronic acid derivatives, betaine, betaine derivatives, amino acids, amino acid derivatives, glycosaminoglycans, glycols, polyols, sugars, sugar alcohols, hydrogenated starch hydrolysates, hydroxy acids, hydroxy acid derivatives, salts of PCA and the like, and combinations thereof. Specific examples of suitable humectants include honey, sorbitol, hyaluronic acid, sodium hyaluronate, betaine, lactic acid, citric acid, sodium citrate, glycolic acid, sodium glycolate, sodium lactate, urea, propylene glycol, butylene glycol, pentylene glycol, ethoxydiglycol, methyl gluceth-10, methyl gluceth-20, polyethylene glycols (as listed in the International Cosmetic Ingredient Dictionary and Handbook such as PEG-2 through PEG 10), propanediol, xylitol, maltitol, or combinations thereof.

The antimicrobial compositions of the disclosure may include one or more humectants in an amount of about 0.01% (by total weight of the composition) to about 20% (by total weight of the composition), or about 0.05% (by total weight of the composition) to about 10% by total weight of the composition), or about 0.1% (by total weight of the composition) to about 5.0% (by total weight of the composition).

As noted above, in preferred embodiments of the present disclosure the concentrated antimicrobial composition can be diluted with a carrier, such as water. For instance, where the antimicrobial composition is a wetting composition, such as described below for use with a wet wipe, the composition will typically include water to dilute the concentrated antimicrobial composition. The antimicrobial compositions can suitably comprise water in an amount of from about 0.01% (by total weight of the composition) to about 99.98% (by total weight of the composition), or from about 1.00% (by total weight of the composition) to about 99.98% (by total weight of the composition), or from about 50.00% (by total weight of the composition) to about 99.98% (by total weight of the composition), or from about 75.00% (by total weight of the composition) to about 99.98% (by total weight of the composition). In some embodiments, water can comprise an amount from about 50.00% (by total weight of the composition) to about 70.00% (by total weight of the composition). In some embodiments, water can comprise an amount greater than 90.00% (by total weight of the composition).

In an embodiment where the antimicrobial composition serves as a wash (e.g. shampoo; surface cleaner; or hand, face, or body wash), the antimicrobial composition will likely include one or more surfactants. In an embodiment where the antimicrobial composition is included in a wipe, the antimicrobial composition may also likely include one or more surfactants. These may be selected from anionic, cationic, nonionic, zwitterionic, and amphoteric surfactants. Amounts of surfactants may range from 0.01 to 30%, or from 10 to 30%, or from 0.05 to 20%, or from 0.10 to 15% by total weight of the final diluted antimicrobial composition. In some embodiments, such as when the wetting composition is used with a wipe, the surfactant can comprise less than 5% by total weight of the final diluted wetting composition.

Suitable anionic surfactants include, but are not limited to, C₈ to C₂₂ alkane sulfates, ether sulfates and sulfonates. Among the suitable sulfonates are primary C₈ to C₂₂ alkane sulfonate, primary C₈ to C₂₂ alkane disulfonate, C₈ to C₂₂ alkene sulfonate, C₈ to C₂₂ hydroxyalkane sulfonate or alkyl glyceryl ether sulfonate. Specific examples of anionic surfactants include ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium laureth sulfate, sodium lauryl sarcosinate, sodium lauroyl sarcosinate, potassium lauryl sulfate, sodium trideceth sulfate, sodium methyl lauroyl taurate, sodium lauroyl isethionate, sodium laureth sulfosuccinate, sodium lauroyl sulfosuccinate, sodium tridecyl benzene sulfonate, sodium dodecyl benzene sulfonate, sodium lauryl amphoacetate and mixtures thereof. Other anionic surfactants include the C₈ to C₂₂ acyl glycinate salts. Suitable glycinate salts include sodium cocoylglycinate, potassium cocoylglycinate, sodium lauroylglycinate, potassium lauroylglycinate, sodium myristoylglycinate, potassium myristoylglycinate, sodium palmitoylglycinate, potassium palmitoylglycinate, sodium stearoylglycinate, potassium stearoylglycinate, ammonium cocoylglycinate and mixtures thereof. Cationic counter-ions to form the salt of the glycinate may be selected from sodium, potassium, ammonium, alkanolammonium and mixtures of these cations.

Suitable cationic surfactants include, but are not limited to alkyl dimethylamines, alkyl amidopropylamines, alkyl imidazoline derivatives, quaternised amine ethoxylates, and quaternary ammonium compounds.

Suitable nonionic surfactants include, but are not limited to, alcohols, acids, amides or alkyl phenols reacted with alkylene oxides, especially ethylene oxide either alone or with propylene oxide. Specific nonionics are C₆ to C₂₂ alkyl phenols-ethylene oxide condensates, the condensation products of C₈ to C₁₃ aliphatic primary or secondary linear or branched alcohols with ethylene oxide, and products made by condensation of ethylene oxide with the reaction products of propylene oxide and ethylenediamine. Other nonionics include long chain tertiary amine oxides, long chain tertiary phosphine oxides and dialkyl sulphoxides, alkyl polysaccharides, amine oxides, block copolymers, castor oil ethoxylates, ceto-oleyl alcohol ethoxylates, ceto-stearyl alcohol ethoxylates, decyl alcohol ethoxylates, dinonyl phenol ethoxylates, dodecyl phenol ethoxylates, end-capped ethoxylates, ether amine derivatives, ethoxylated alkanolamides, ethylene glycol esters, fatty acid alkanolamides, fatty alcohol alkoxylates, lauryl alcohol ethoxylates, mono-branched alcohol ethoxylates, natural alcohol ethoxylates, nonyl phenol ethoxylates, octyl phenol ethoxylates, oleyl amine ethoxylates, random copolymer alkoxylates, sorbitan ester ethoxylates, stearic acid ethoxylates, stearyl amine ethoxylates, synthetic alcohol ethoxylates, tall oil fatty acid ethoxylates, tallow amine ethoxylates and trid tridecanol ethoxylates.

Suitable zwitterionic surfactants include, for example, alkyl amine oxides, alkyl hydroxysultaines, silicone amine oxides, and combinations thereof. Specific examples of suitable zwitterionic surfactants include, for example, 4-[N,N-di(2-hydroxyethyl)-N-octadecylammonio]-butane-1-carboxylate, S—[S-3-hydroxypropyl-S-hexadecylsulfonio]-3-hydroxypentane-1-sulfate, 3-[P,P-diethyl-P-3,6,9-trioxatetradexopcylphosphonio]-2-hydroxypropane-1-phosphate, 3-[N,N-dipropyl-N-3-dodecoxy-2-hydroxypropylammonio]-propane-1-phosphonate, 3-(N,N-dimethyl-N-hexadecylammonio) propane-1-sulfonate, 3-(N,N-dimethyl-N-hexadecylammonio)-2-hydroxypropane-1-sulfonate, 4-[N,N-di(2-hydroxyethyl)-N-(2-hydroxydodecyl) ammonio]-butane-1-carboxylate, 3-[S-ethyl-S-(3-dodecoxy-2-hydroxypropyl) sulfonio]-propane-1-phosphate, 3-[P,P-dimethyl-P-dodecylphosphonio]-propane-1-phosphonate, 5-[N,N-di(3-hydroxypropyl)-N-hexadecylammonio]-2-hydroxy-pentane-1-sulfate, lauryl hydroxysultaine and combinations thereof.

Suitable amphoteric surfactants include, but are not limited to, derivatives of aliphatic quaternary ammonium, phosphonium, and sulfonium compounds, in which the aliphatic radicals can be straight or branched chain, and wherein one of the aliphatic substituents contains from about 8 to about 18 carbon atoms and one substituent contains an anionic group, e.g., carboxy, sulfonate, sulfate, phosphate, or phosphonate. Illustrative amphoterics are coco dimethyl carboxymethyl betaine, cocoamidopropyl betaine, cocobetaine, oleyl betaine, cetyl dimethyl carboxymethyl betaine, lauryl bis-(2-hydroxyethyl) carboxymethyl betaine, stearyl bis-(2-hydroxypropyl) carboxymethyl betaine, oleyl dimethyl gamma-carboxypropyl betaine, lauryl bis-(2-hydroxypropyl) alpha-carboxyethyl betaine, cocoamphoacetates, and combinations thereof. The sulfobetaines may include stearyl dimethyl sulfopropyl betaine, lauryl dimethyl sulfoethyl betaine, lauryl bis-(2-hydroxyethyl) sulfopropyl betaine and combinations thereof.

### Rheology Modifier

Optionally, one or more rheology modifiers, such as thickeners, may be added to the antimicrobial compositions. Suitable rheology modifiers are compatible with the antimicrobial agent. As used herein, “compatible” refers to a compound that, when mixed with the antimicrobial agent, does not adversely affect the antimicrobial properties of same.

A thickening system is used in the antimicrobial compositions to adjust the viscosity and stability of the compositions. Specifically, thickening systems prevent the composition from running off of the hands or body during dispensing and use of the composition. When the antimicrobial composition is used with a wipe product, a thicker formulation can be used to prevent the composition from migrating from the wipe substrate.

The thickening system should be compatible with the compounds used in the present disclosure; that is, the thickening system, when used in combination with the antimicrobial compounds, should not precipitate out, form a coacervate, or prevent a user from perceiving the conditioning benefit (or other desired benefit) to be gained from the composition. The thickening system may include a thickener which can provide both the thickening effect desired from the thickening system and a conditioning effect to the user's skin.

Thickeners may include, cellulosics, gums, acrylates, starches and various polymers. Suitable examples include but are not limited to hydroxethyl cellulose, xanthan gum, guar gum, potato starch, and corn starch. In some embodiments, PEG-150 stearate, PEG-150 distearate, PEG-175 diisostearate, polyglyceryl-10 behenate/eicosadioate, disteareth-100 IPDI, polyacrylamidomethylpropane sulfonic acid, butylated PVP, and combinations thereof may be suitable.

While the viscosity of the compositions will typically depend on the thickener used and the other components of the compositions, the thickeners of the compositions suitably provide for a composition having a viscosity in the range of greater than 1 cP to about 30,000 cP or more. In another embodiment, the thickeners provide compositions having a viscosity of from about 100 cP to about 20,000 cP. In yet another embodiment, thickeners provide compositions having a viscosity of from about 200 cP to about 15,000 cP. In embodiments where the compositions are included in a wipe, the viscosity may range from about 1 cP to about 2000 cP. In some embodiments, it is preferable to have a viscosity of the composition be less than 500 cP.

Typically, the antimicrobial compositions of the present disclosure include the thickening system in an amount of no more than about 20% (by total weight of the composition), or from about 0.01% (by total weight of the composition) to about 20% (by total weight of the composition), in a final diluted form. In another aspect the thickening system is present in the antimicrobial composition in an amount of from about 0.10% (by total weight of the composition) to about 10% (by total weight of the composition), or from about 0.25% (by total weight of the composition) to about 5% (by total weight of the composition), or from about 0.5% (by total weight of the composition) to about 2% (by total weight of the composition), in a final diluted form.

### Emulsifiers

In one embodiment, the antimicrobial compositions may include hydrophobic and hydrophilic ingredients, such as a lotion or cream. Generally, these emulsions have a dispersed phase and a continuous phase, and are generally formed with the addition of a surfactant or a combination of surfactants with varying hydrophilic/lipophilic balances (HLB). Suitable emulsifiers include surfactants having HLB values from 0 to 20, or from 2 to 18. Suitable non-limiting examples include Ceteareth-20, Cetearyl Glucoside, Ceteth-10, Ceteth-2, Ceteth-20, Cocamide MEA, Glyceryl Laurate, Glyceryl Stearate, PEG-100 Stearate, Glyceryl Stearate, Glyceryl Stearate SE, Glycol Distearate, Glycol Stearate, Isosteareth-20, Laureth-23, Laureth-4, Lecithin, Methyl Glucose Sesquistearate, Oleth-10, Oleth-2, Oleth-20, PEG-100 Stearate, PEG-20 Almond Glycerides, PEG-20 Methyl Glucose Sesquistearate, PEG-25 Hydrogenated Castor Oil, PEG-30 Dipolyhydroxystearate, PEG-4 Dilaurate, PEG-40 Sorbitan Peroleate, PEG-60 Almond Glycerides, PEG-7 Olivate, PEG-7 Glyceryl Cocoate, PEG-8 Dioleate, PEG-8 Laurate, PEG-8 Oleate, PEG-80 Sorbitan Laurate, Polysorbate 20, Polysorbate 60, Polysorbate 80, Polysorbate 85, Propylene Glycol Isostearate, Sorbitan Isostearate, Sorbitan Laurate, Sorbitan Monostearate, Sorbitan Oleate, Sorbitan Sesquioleate, Sorbitan Stearate, Sorbitan Trioleate, Stearamide MEA, Steareth-100, Steareth-2, Steareth-20, Steareth-21. The compositions can further include surfactants or combinations of surfactants that create liquid crystalline networks or liposomal networks. Suitable non-limiting examples include OLIVEM 1000 (INCI: Cetearyl Olivate (and) Sorbitan Olivate (available from HallStar Company (Chicago, IL)); ARLACEL LC (INCI: Sorbitan Stearate (and) Sorbityl Laurate, commercially available from Croda (Edison, NJ)); CRYSTALCAST MM (INCI: Beta Sitosterol (and) Sucrose Stearate (and) Sucrose Distearate (and) Cetyl Alcohol (and) Stearyl Alcohol, commercially available from MMP Inc. (South Plainfield, NJ)); UNIOX CRISTAL (INCI: Cetearyl Alcohol (and) Polysorbate 60 (and) Cetearyl Glucoside, commercially available from Chemyunion (Sao Paulo, Brazil). Other suitable emulsifiers include lecithin, hydrogenated lecithin, lysolecithin, phosphatidylcholine, phospholipids, and combinations thereof.

### Adjunct Ingredients

The antimicrobial compositions of the present disclosure may additionally include adjunct ingredients conventionally found in cosmetic, pharmaceutical, medical, household, industrial, or personal care compositions/products in an established fashion and at established levels. Such ingredients are typically added in the final diluted form of the antimicrobial composition. For example, the antimicrobial compositions may comprise additional compatible pharmaceutically active and compatible materials for combination therapy, such as antioxidants, anti-parasitic agents, antipruritics, antifungals, antiseptic actives, biological actives, astringents, keratolytic actives, local anaesthetics, anti-stinging agents, anti-reddening agents, skin soothing agents, external analgesics, film formers, skin exfoliating agents, sunscreens, and combinations thereof.

Other suitable additives that may be included in the antimicrobial compositions of the present disclosure include compatible colorants, deodorants, emulsifiers, anti-foaming agents (when foam is not desired), lubricants, skin conditioning agents, skin protectants and skin benefit agents (e.g., aloe vera and tocopheryl acetate), solvents (e.g., water soluble glycol and glycol ethers, glycerin, water soluble polyethylene glycols, water soluble polyethylene glycol ethers, water soluble polypropylene glycols, water soluble polypropylene glycol ethers, dimethylisosorbide), solubilizing agents, suspending agents, builders, (e.g., alkali and alkaline earth metal salts of carbonate, bicarbonate, phosphate, hydrogen phosphate, dihydrogen phosphate, sulfate hydrogen sulfate), wetting agents, pH adjusting ingredients (a suitable pH range of the compositions can be from about 3.5 to about 8), chelators, propellants, dyes and/or pigments, and combinations thereof.

Another component that may be suitable for addition to the antimicrobial compositions is a fragrance. Any compatible fragrance may be used. Typically, the fragrance is present in an amount from about 0% (by weight of the composition) to about 5% (by weight of the composition), and more typically from about 0.01% (by weight of the composition) to about 3% (by weight of the composition), in a final diluted form of the composition. In one desirable embodiment, the fragrance will have a clean, fresh and/or neutral scent to create an appealing delivery vehicle for the end consumer.

Organic sunscreens that may be present in the antimicrobial compositions include ethylhexyl methoxycinnamate, avobenzone, octocrylene, benzophenone-4, phenylbenzimidazole sulfonic acid, homosalate, oxybenzone, benzophenone-3, ethylhexyl salicylate, and mixtures thereof.

In addition to the antimicrobial agents discussed herein, the antimicrobial composition may include various combinatorial antimicrobial agents to increase shelf life. Some suitable combinatorial antimicrobial agents that may be used in the present disclosure include traditional antimicrobial agents. As used herein, “traditional antimicrobial agents” means compounds that have been historically recognized by regulatory bodies as providing an antimicrobial effect, such as those listed in the European Union's Annex V list of preservatives allowed in cosmetics products. Traditional antimicrobial agents include, but are not limited to: propionic acid and salts thereof; salicylic acid and salts thereof; sorbic acid and salts thereof; benzoic acid and salts and esters thereof; formaldehyde; paraformaldehyde; o-phenylphenol and salts thereof; zinc pyrithione; inorganic sulfites; hydrogen sulfites; chlorobutanol; benzoic parabens, such as methylparaben, propylparaben, butylparaben, ethylparaben, isopropylparaben, isobutylparaben, benzylparaben, sodium methylparaben and sodium propylparaben; dehydroacetic acid and salts thereof; formic acid and salts thereof; dibromohexamidine isethionate; thimerosal; phenylmercuric salts; undecylenic acid and salts thereof; hexetidine; 5-bromo-5-nitro-1,3-dioxane; 2-bromo-2-nitropropane-1,3,-diol; dichlorobenzyl alcohol; triclocarban; p-chloro-m-cresol; triclosan; chloroxylenol; imidazolidinyl urea; polyaminopropyl biguanide; phenoxyethanol, methenamine; quaternium-15; climbazole; DMDM hydantoin; benzyl alcohol; piroctone olamine; bromochlorophene; o-cymen-5-ol; methylchloroisothiazolinone; methylisothiazolinone; chlorophene; chloroacetamide; chlorhexidine; chlorhexidine diacetate; chlorhexidine digluconate; chlorhexidine dihydrochloride; phenoxyisopropanol; alkyl (C12-C22) trimethyl ammonium bromide and chlorides; dimethyl oxazolidine; diazolidinyl urea; hexamidine; hexamidine diisethionate; glutaral; 7-ethylbicyclooxazolidine; chlorphenesin; sodium hydroxymethylglycinate; silver chloride; benzethonium chloride; benzalkonium chloride; benzalkonium bromide; benzylhemiformal; iodopropynyl butylcarbamate; ethyl lauroyl arginate HCl; citric acid and silver citrate.

Other combinatorial antimicrobial agents that may be added to the antimicrobial compositions of the present disclosure include non-traditional antimicrobial agents that are known to exhibit antimicrobial effects in addition to their primary functions, but that have not historically been recognized as antimicrobial agents by regulatory bodies (such as on the European Union's Annex V list). Examples of these non-traditional antimicrobial agents include, but are not limited to, caprylyl glycol, sodium coco-PG dimonium chloride phosphate, phenylpropanol, lactic acid and salts thereof, caprylhydroxamic acid, levulinic acid and salts thereof, sodium lauroyl lactylate, phenethyl alcohol, sorbitan caprylate, glyceryl caprate, glyceryl caprylate, ethylhexylglycerin, p-anisic acid and salts thereof, gluconolactone, decylene glycol, 1,2-hexanediol, glucose oxidase and lactoperoxidase, leuconostoc/radish root ferment filtrate and glyceryl laurate.

The amount of the combinatorial antimicrobial agents in the antimicrobial compositions is dependent on the relative amounts of other components present within the composition. For example, in some embodiments, the combinatorial antimicrobial agent can be present in the compositions in an amount between about 0.001% to about 5% (by total weight of the composition), in some embodiments between about 0.01 to about 3% (by total weight of the composition), and in some embodiments, between about 0.05% to about 1.0% (by total weight of the composition), in a final diluted form of the antimicrobial composition. In some embodiments, the combinatorial antimicrobial agent can be present in the composition in an amount less than 0.2% (by total weight of the composition), in a final diluted form of the antimicrobial composition.

However, in some embodiments, the antimicrobial composition is substantially free of any combinatorial antimicrobial agent, yet still provides adequate efficacy against microbial growth through the inclusion of hydroxyacetophenone and a glycol. Thus, in some embodiments, the antimicrobial composition does not include a traditional antimicrobial agent or any other non-traditional antimicrobial agent other than hydroxyacetophenone and a glycol, such as caprylyl glycol. These embodiments can provide the benefit of simpler formulations and improved consumer appeal.

### Delivery Vehicles

The antimicrobial compositions of the present disclosure may be used in combination with a product that can serve as a delivery vehicle for the antimicrobial composition. For example, the antimicrobial composition may be incorporated into or onto a substrate, such as a wipe substrate, an absorbent substrate, a fabric or cloth substrate, a tissue or paper towel substrate, or the like. In one embodiment, the antimicrobial composition may be used in combination with a wipe substrate to form a wet wipe or may be a wetting composition for use in combination with a wipe which may be dispersible. In other embodiments, the antimicrobial composition may be incorporated into wipes such as wet wipes, hand wipes, face wipes, cosmetic wipes, cloths and the like. In yet other embodiments, the antimicrobial compositions described herein can be used in combination with numerous personal care products, such as absorbent articles. Absorbent articles of interest are diapers, training pants, adult incontinence products, feminine hygiene products, and the like; bath or facial tissue; and paper towels. Personal protective equipment articles of interest include but are not limited to masks, gowns, gloves, caps, and the like.

In one embodiment, the wet wipe may comprise a nonwoven material that is wetted with an aqueous solution termed the “wetting composition,” which may include or be composed entirely of the antimicrobial compositions disclosed herein. As used herein, the nonwoven material comprises a fibrous material or substrate, where the fibrous material or substrate comprises a sheet that has a structure of individual fibers or filaments randomly arranged in a mat-like fashion. Nonwoven materials may be made from a variety of processes including, but not limited to, airlaid processes, wet-laid processes such as with cellulosic-based tissues or towels, hydroentangling processes, staple fiber carding and bonding, melt blown, and solution spinning.

The fibers forming the fibrous material may be made from a variety of materials including natural fibers, synthetic fibers, and combinations thereof. The choice of fibers may depend upon, for example, the intended end use of the finished substrate and the fiber cost. For instance, suitable fibers may include, but are not limited to, natural fibers such as cotton, linen, jute, hemp, wool, wood pulp, etc. Similarly, suitable fibers may also include: regenerated cellulosic fibers, such as viscose rayon and cuprammonium rayon; modified cellulosic fibers, such as cellulose acetate; or synthetic fibers, such as those derived from polypropylenes, polyethylenes, polyolefins, polyesters, polyamides, polyacrylics, etc. Regenerated cellulose fibers, as briefly discussed above, include rayon in all its varieties as well as other fibers derived from viscose or chemically modified cellulose, including regenerated cellulose and solvent-spun cellulose, such as Lyocell. Among wood pulp fibers, any known papermaking fibers may be used, including softwood and hardwood fibers. Fibers, for example, may be chemically pulped or mechanically pulped, bleached or unbleached, virgin or recycled, high yield or low yield, and the like. Chemically treated natural cellulosic fibers may be used, such as mercerized pulps, chemically stiffened or crosslinked fibers, or sulfonated fibers.

In addition, cellulose produced by microbes and other cellulosic derivatives may be used. As used herein, the term “cellulosic” is meant to include any material having cellulose as a major constituent, and, specifically, comprising at least 50 percent by weight cellulose or a cellulose derivative. Thus, the term includes cotton, typical wood pulps, non-woody cellulosic fibers, cellulose acetate, cellulose triacetate, rayon, thermomechanical wood pulp, chemical wood pulp, debonded chemical wood pulp, milkweed, or bacterial cellulose. Blends of one or more of any of the previously described fibers may also be used, if so desired.

The fibrous material may be formed from a single layer or multiple layers. In the case of multiple layers, the layers are generally positioned in a juxtaposed or surface-to-surface relationship and all or a portion of the layers may be bound to adjacent layers. The fibrous material may also be formed from a plurality of separate fibrous materials wherein each of the separate fibrous materials may be formed from a different type of fiber.

Airlaid nonwoven fabrics are particularly well suited for use as wet wipes. The basis weights for airlaid nonwoven fabrics may range from about 20 to about 200 grams per square meter (gsm) with staple fibers having a denier of about 0.5 to about 10 and a length of about 6 to about 15 millimeters. Wet wipes may generally have a fiber density of about 0.025 g/cc to about 0.2 g/cc. Wet wipes may generally have a basis weight of about 20 gsm to about 150 gsm. More desirably the basis weight may be from about 30 to about 90 gsm. Even more desirably the basis weight may be from about 50 gsm to about 75 gsm.

Processes for producing airlaid non-woven basesheets are described in, for example, published U.S. Pat. App. No. 2006/0008621, herein incorporated by reference to the extent it is consistent herewith.

In some embodiments when the antimicrobial composition is used as a wetting composition with a substrate, the wetting composition can be applied to the substrate at an add-on percentage of from about 30% to about 500%, or from about 125% to about 400%, or from about 150% to about 350%.

### Test Methods

### Stability Testing:

Concentrate compositions as described herein were batched in the laboratory by first combining all glycols and surfactants in a vessel and blending thoroughly. This mixture was then heated to 50° C. and the hydroxyacetophenone was incorporated slowly with mixing. Once all hydroxyacetophenone was dissolved, the mixture was then cooled to room temperature.

Samples from each batch were then placed into 2-oz. glass jars and placed into aging at the selected temperature conditions (for example, 5° C., 25° C., 40° C. or other conditions as noted herein). Samples aged at temperature above 25° C. were placed into temperature-controlled ovens, while samples stored at temperatures below 25° C. were stored in temperature-controlled refrigerators or freezers. 25° C. samples were stored at room temperature in a controlled laboratory environment.

Samples were then pulled from the aging chambers at pre-determined intervals described herein (for example, 1 month), and the formulations were inspected for visible signs of physical instability, including precipitation, separation, and changes in turbidity. Any visible indications of precipitation or separation are considered a failure of this stability test. Samples were then placed back into the aging chambers until the time of the next evaluation.

### EMBODIMENTS

Embodiment 1: A composition comprising: at least one glycol, wherein the at least one glycol includes a first glycol comprising a carbon chain with less than six carbons; a non-ionic surfactant; hydroxyacetophenone, wherein the hydroxyacetophenone comprises at least 10% of the composition by weight.

Embodiment 2: The composition of embodiment 1, wherein the composition is stable for at least 1 month at 5° C. according to a Stability Test as described herein.

Embodiment 3: The composition of any one of embodiments 1 or 2, wherein the first glycol is selected from the group consisting of butylene glycol, propylene glycol, and methylpropanediol.

Embodiment 4: The composition of any one of the preceding embodiments, wherein the at least one glycol includes a second glycol.

Embodiment 5: The composition of embodiment 4, wherein the second glycol is caprylyl glycol.

Embodiment 6: The composition of any one of the preceding embodiments, wherein the non-ionic surfactant comprises at least one of polysorbate-20, polysorbate-80, PEG-40 hydrogenated castor oil, polyglycerly-3 caprate, trideceth-6, and trideceth-18.

Embodiment 7: The composition of embodiment 6, wherein the non-ionic surfactant comprises polysorbate-20.

Embodiment 8: The composition of any one of the preceding embodiments, wherein a ratio of the non-ionic surfactant to the hydroxyacetophenone is at least 1.0.

Embodiment 9: A composition comprising: a first glycol, the first glycol comprising a carbon chain with less than six carbons; a second glycol; a non-ionic surfactant; and hydroxyacetophenone.

Embodiment 10: The composition of embodiment 9, wherein the hydroxyacetophenone comprises at least 10% by weight of the composition.

Embodiment 11: The composition of embodiment 9 or 10, wherein the first glycol is selected from the group consisting of butylene glycol, propylene glycol, and methylpropanediol.

Embodiment 12: The composition of any one of embodiments 9-11, wherein the second glycol is caprylyl glycol.

Embodiment 13: The composition of any one of embodiments 9-12, wherein the non-ionic surfactant comprises at least one of polysorbate-20, polysorbate-80, PEG-40 hydrogenated castor oil, polyglycerly-3 caprate, trideceth-6, and trideceth-18.

Embodiment 14: The composition of embodiment 13, wherein the non-ionic surfactant comprises polysorbate-20.

Embodiment 15: The composition of any one of embodiments 9-14, wherein the composition is stable for at least 1 month at 5° C. according to a Stability Test as described herein.

Embodiment 16: A composition comprising: a first glycol at a first weight percentage of the composition; caprylyl glycol at a second weight percentage of the composition, wherein the first weight percentage and the second weight percentage comprises a total glycol weight percentage of the composition; and hydroxyacetophenone at an amount of at least 10% of the composition by weight; wherein a ratio of the total glycol weight percentage to the amount of hydroxyacetophenone is greater than 4.0.

Embodiment 17 The composition of embodiment 16, wherein the composition is substantially free from a surfactant.

Embodiment 18: The composition of embodiment 16 or 17, the composition is stable for at least 1 month at 5° C. according to a Stability Test as described herein.

Embodiment 19: The composition of any one of embodiments 16-18, wherein the first glycol comprises at least one of butylene glycol, methylpropanediol, and combinations thereof.

Embodiment 20: The composition of any one of embodiments 16-19, wherein a ratio of the second weight percentage of the composition to the amount of hydroxyacetophenone is greater than 2.5.

When introducing elements of the present disclosure, the articles “a”, “an”, “the” and “said” are intended to mean that there are one or more of the elements. The terms “comprising”, “including” and “having” are intended to be inclusive and mean that there may be additional elements other than the listed elements. Many modifications and variations of the present disclosure can be made without departing from the spirit and scope thereof. Therefore, the exemplary embodiments described above should not be used to limit the scope of the disclosure.

1. A composition comprising:
at least one glycol, wherein the at least one glycol includes a first glycol comprising a carbon chain with less than six carbons;
a non-ionic surfactant;
hydroxyacetophenone, wherein the hydroxyacetophenone comprises at least 10% of the composition by weight;
wherein the composition is stable for at least 1 month at 5° C. according to Stability Testing as described herein.

2. (canceled)

3. The composition of claim 1, wherein the first glycol is selected from the group consisting of butylene glycol, propylene glycol, and methylpropanediol.

4. The composition of claim 1, wherein the at least one glycol includes a second glycol.

5. The composition of claim 4, wherein the second glycol is caprylyl glycol.

6. The composition of claim 1, wherein the non-ionic surfactant comprises at least one of polysorbate-20, polysorbate-80, PEG-40 hydrogenated castor oil, polyglyceryl-3 caprate, trideceth-6, and trideceth-18.

7. The composition of claim 6, wherein the non-ionic surfactant comprises polysorbate-20.

8. The composition of claim 1, wherein a ratio of the non-ionic surfactant to the hydroxyacetophenone is at least 1.0.

9. A composition comprising:
a first glycol, the first glycol comprising a carbon chain with less than six carbons;
a second glycol;
a non-ionic surfactant; and
hydroxyacetophenone;
wherein the composition is stable for at least 1 month at 5° C. according to Stability Testing as described herein.

10. The composition of claim 9, wherein the hydroxyacetophenone comprises at least 10% by weight of the composition.

11. The composition of claim 9, wherein the first glycol is selected from the group consisting of butylene glycol, propylene glycol, and methylpropanediol.

12. The composition of claim 9, wherein the second glycol is caprylyl glycol.

13. The composition of claim 9, wherein the non-ionic surfactant comprises at least one of polysorbate-20, polysorbate-80, PEG-40 hydrogenated castor oil, polyglyceryl-3 caprate, trideceth-6, and trideceth-18

14. The composition of claim 13, wherein the non-ionic surfactant comprises polysorbate-20.

15. (canceled)

16. A composition comprising:
a first glycol at a first weight percentage of the composition;
caprylyl glycol at a second weight percentage of the composition, wherein the first weight percentage and the second weight percentage comprises a total glycol weight percentage of the composition; and
hydroxyacetophenone at an amount of at least 10% of the composition by weight;
wherein a ratio of the total glycol weight percentage to the amount of hydroxyacetophenone is greater than 4.0; and
wherein the composition is stable for at least 1 month at 5° C. according to Stability Testing as described herein.

17. The composition of claim 16, wherein the composition is substantially free from a non-ionic surfactant.

18. (canceled)

19. The composition of claim 16, wherein the first glycol comprises at least one of butylene glycol, methylpropanediol, and combinations thereof.

20. The composition of claim 16, wherein a ratio of the second weight percentage of the composition to the amount of hydroxyacetophenone is greater than 2.5.

21. The composition of claim 1, wherein a ratio of the non-ionic surfactant to the first glycol is 9:20-25:10.

22. The composition of claim 9, wherein a ratio of the non-ionic surfactant to the first glycol is 9:20-25:10.

23. The composition of claim 16, wherein a ratio of the non-ionic surfactant to the first glycol is 9:20-25:10.
